(19) United States
(12) Patent Application Publication
(10) Pub. No.: US 2016/0110132 A1
(43) Pub. Date: Apr. 21, 2016

(54) Dynamic Adjustment Of Speed of Memory

(71) Applicant: MediaTek Inc., Hsinchu (TW)

(72) Inventors: Chun-Hang Wei, Yilan County (TW); Hung-Lin Chou, Zhubei (TW); Nicholas Ching Hui Tang, Hsinchu County (TW); Jia-Ming Chen, Hsinchu County (TW)

(21) Appl. No.: 14/967,244

(22) Filed: Dec. 11, 2015

Related U.S. Application Data
(60) Provisional application No. 62/101,513, filed on Jan. 9, 2015.

(51) Int. Cl. G06F 3/06

(52) U.S. Cl. CPC G06F 3/0629; G06F 3/0604; G06F 3/0638; G06F 3/0673

(57) ABSTRACT

A technique, as well as select implementations thereof, pertaining to dynamic adjustment of speed of memory is described. The technique may involve obtaining information indicative of memory transactions associated with a memory device from an external memory interface coupled to the memory device. The technique may also involve determining a runtime bandwidth of the memory device according to the memory transactions. The technique may further involve comparing the runtime bandwidth of the memory device to at least one threshold bandwidth. The technique may additionally involve adjusting the speed of the memory device according to a result of the comparing.

### CROSS REFERENCE TO RELATED PATENT APPLICATION

The present disclosure claims the priority benefit of U.S. Provisional Patent Application No. 62/101,513, filed on 9 Jan. 2015, which is incorporated by reference in its entirety.

### TECHNICAL FIELD

The present disclosure is generally related to memory devices and, more particularly, to methods and devices for dynamic adjustment of speed of memory.

### BACKGROUND

Unless otherwise indicated herein, approaches described in this section are not prior art to the claims listed below and are not admitted to be prior art by inclusion in this section.

Portable electronic apparatuses such as smartphones, tablet computers and wearable apparatuses typically operate on electrical power supplied by a battery. In general, the hardware of a portable electronic apparatus, such as its central processing unit (CPU) and memory, need not operate at a high operating frequency, or speed, unless performance is needed so as to conserve power. When hardware operates at a high frequency, there is generally high consumption of battery power as well as thermal issues.

Conventional approaches typically employ dynamic voltage and frequency scaling (DVFS), a power management technique, in portable electronic apparatuses to adjust the operating frequency of the CPU based on CPU loading so as to achieve system power saving. However, there is currently no solution for adjustment of the speed or frequency of memory. The speed of the memory is often constant, e.g., at full speed, even when there is no memory bandwidth requirement. Current operating systems do not detect memory bandwidth requirement to adjust memory speed accordingly.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

In one example implementation, a method may involve obtaining information indicative of memory transactions associated with a memory device from an external memory interface coupled to the memory device. The method may also involve determining a runtime bandwidth of the memory device according to the memory transactions. The method may further involve comparing the runtime bandwidth of the memory device to at least one threshold bandwidth. The method may additionally involve adjusting the speed of the memory device according to a result of the comparing.

In another example implementation, an apparatus may include a first module, a second module and a third module. At least one of the first module, the second module and the third module may be implemented at least partially in hardware. The first module may be configured to provide a trigger signal from time to time. The second module may be configured to receive the trigger signal and obtain information indicative of memory transactions associated with a memory device from an external memory interface coupled to the memory device responsive to receiving the trigger signal. The second module may be also configured to determine a runtime bandwidth of the memory device according to the memory transactions. The second module may be further configured to compare the runtime bandwidth of the memory device to one or more threshold bandwidths. The third module may be configured to adjust the speed of the memory device according to a result of the comparing by the second module.

In still another example implementation, a method may involve dynamically detecting a runtime bandwidth of a memory device. The method may also involve adjusting a speed of the memory device responsive to the detecting.

In yet another example implementation, an apparatus may include a processor, an external memory interface and a memory device communicatively coupled to the processor through the external memory interface. The processor may be configured to dynamically detect a runtime bandwidth of the memory device and adjust a speed of the memory device responsive to the detecting.

Advantageously, implementations in accordance with the present disclosure may help conserve energy by switching a memory device to a lower speed when high-speed operation is not required. Implementations in accordance with the present disclosure may detect runtime bandwidth of the memory device through external memory interface (EMI) and adjust the memory speed accordingly. For instance, speed of the memory device may be decreased, increased or maintained depending on the current runtime bandwidth of the memory device.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example algorithm in accordance with an implementation of the present disclosure.

FIG. 2 is a diagram of an example scenario in accordance with an implementation of the present disclosure.

FIG. 3 is a diagram of an example scenario in accordance with another implementation of the present disclosure.

FIG. 4 is a diagram of an example scenario in accordance with yet another implementation of the present disclosure.

FIG. 5 is a block diagram of an example apparatus in accordance with an implementation of the present disclosure.

FIG. 6 is a block diagram of an example apparatus in accordance with another implementations of the present disclosure.

FIG. 7 is a flowchart of an example process in accordance with an implementation of the present disclosure.

FIG. 8 is a flowchart of an example process in accordance with another implementation of the present disclosure.

### DETAILED DESCRIPTION OF PREFERRED EMBODIMENTS

### Overview

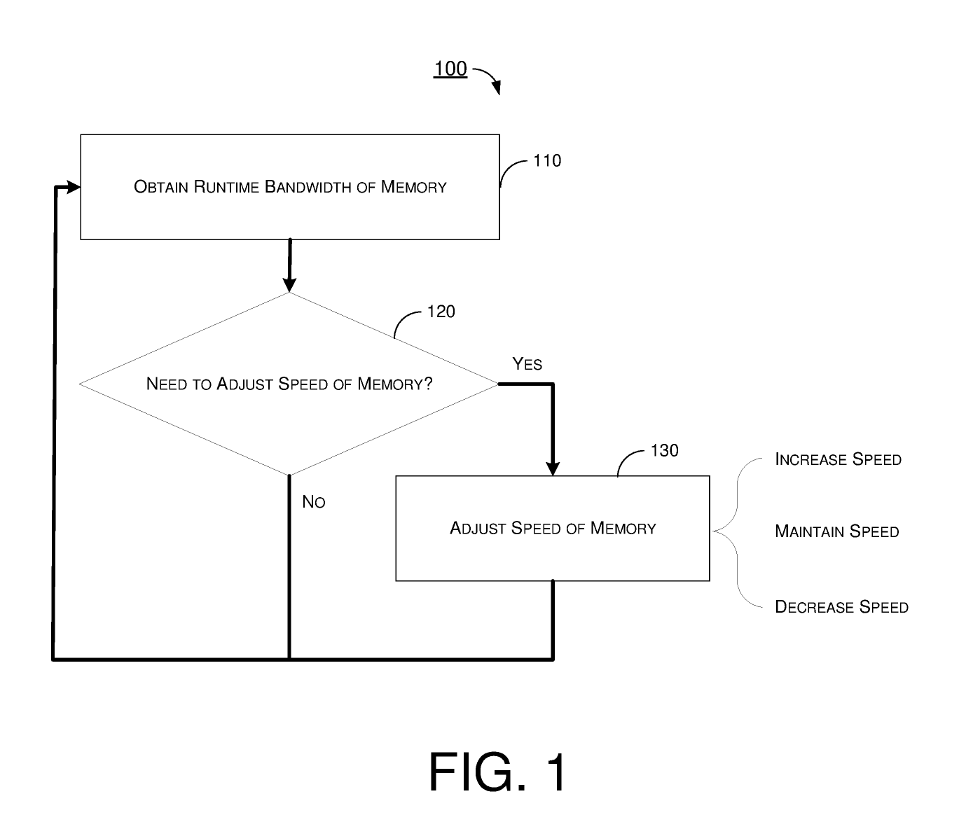

FIG. 1 illustrates an example algorithm 100 pertaining to dynamic adjustment of the speed of a memory. Algorithm 100 may involve one or more operations, actions, or functions as represented by one or more blocks such as blocks 110, 120 and 130. Although illustrated as discrete blocks, various blocks of algorithm 100 may be divided into additional blocks, combined into fewer blocks, or eliminated, depending on the desired implementation. Algorithm 100 may be implemented by a control logic which may include a combination of hardware and software, firmware and/or middleware.

At 110, algorithm 100 may involve obtaining information on runtime bandwidth of a memory device. For instance, the control logic may obtain information indicative of memory transactions associated with the memory device from an external memory interface (EMI) coupled to the memory device and, according to the memory transactions, the control logic may determine a runtime bandwidth of the memory device. The control logic may determine the runtime bandwidth of the memory device by obtaining a value counted by a counter or timer, which may be implemented in hardware or software. The counted value may indicate an amount of data transmitted by the memory device through the external memory interface. To obtain the runtime bandwidth, the control logic may divide the amount of data transmitted through the EMI by a length of time during which the amount of data was transmitted. In other words, the runtime bandwidth of the memory device can be monitored based on an amount of data transmission actually occurring in/through the memory device. Algorithm 100 may proceed from 110 to 120.

At 120, algorithm 100 may involve determining whether there is a need to adjust the speed of the memory device. For instance, the control logic may compare the runtime bandwidth of the memory device to one or more threshold bandwidths and, depending on a result of the comparison, the control logic may decrease, maintain or increase the speed of the memory device. The result of the comparison may indicate either or both of the following: (1) whether the runtime bandwidth of the memory device exceeds the one or more thresholds bandwidths, and (2) the associated difference(s). In an event that it is determined that there is no need to adjust the speed of the memory device, the control logic may maintain the current speed of the memory device and algorithm 100 may proceed from 120 to 110 to repeat the above-described portions of algorithm 100. Otherwise, in an event that it is determined that there is a need to adjust the speed of the memory device, algorithm 100 may proceed from 120 to 130.

It is noteworthy that, prior to comparing the runtime bandwidth of the memory device to the one or more threshold bandwidths, the control logic may determine which one of the one or more threshold bandwidths to be used for comparison according to a system condition in which the memory device is operating. It is also noteworthy that the memory device or an apparatus including or cooperating with the memory device may be in one of multiple operational states, and each of the operational states may correspond to a respective threshold bandwidth of multiple threshold bandwidths. Accordingly, prior to comparing the runtime bandwidth of the memory device to the one or more threshold bandwidths, the control logic may determine a current operational state of the memory device or the apparatus including or cooperating with the memory device and select a corresponding threshold bandwidth from the multiple threshold bandwidths. It is also noteworthy that, in addition to the result of the comparison, various other factors may be involved in determining whether and/or how to adjust the speed of the memory device. For example, in some operational states of the memory device or the apparatus including or cooperating with the memory device, the comparison and/or adjustment may be disabled.

At 130, algorithm 100 may involve adjusting the speed of the memory device. For instance, the control logic may adjust either or both of a supply voltage and a clock rate of the memory device. In response to a comparison result that the runtime bandwidth is lower than a threshold bandwidth (e.g., a low threshold bandwidth) of the one or more threshold bandwidths, the control logic may decrease the speed of the memory device. In response to a comparison result that the runtime bandwidth is higher than a threshold bandwidth (e.g., a high threshold bandwidth) of the one or more threshold bandwidths, the control logic may increase the speed of the memory device. When the current runtime bandwidth of the memory device is within a range (e.g., between the low threshold bandwidth and the high threshold bandwidth), the control logic may maintain the speed of the memory device. In some implementations there may be a single threshold bandwidths and in other implementations there may be multiple threshold bandwidths. In one embodiment, the speed of the memory device may be decreased (or increased) to a predetermined speed. In another embodiment, the speed of the memory device may be decreased (or increased) to one of a plurality of predetermined speeds, according to the result of the comparison. For example, different operational states, threshold bandwidths and/or differences from the threshold bandwidths may be associated with different predetermined speeds.

More detailed description pertaining to a scenario of a single threshold bandwidths and a scenario of multiple threshold bandwidths is provided below with respect to apparatus 600. Algorithm 100 may proceed from 130 to 110 to repeat the above-described portions of algorithm 100.

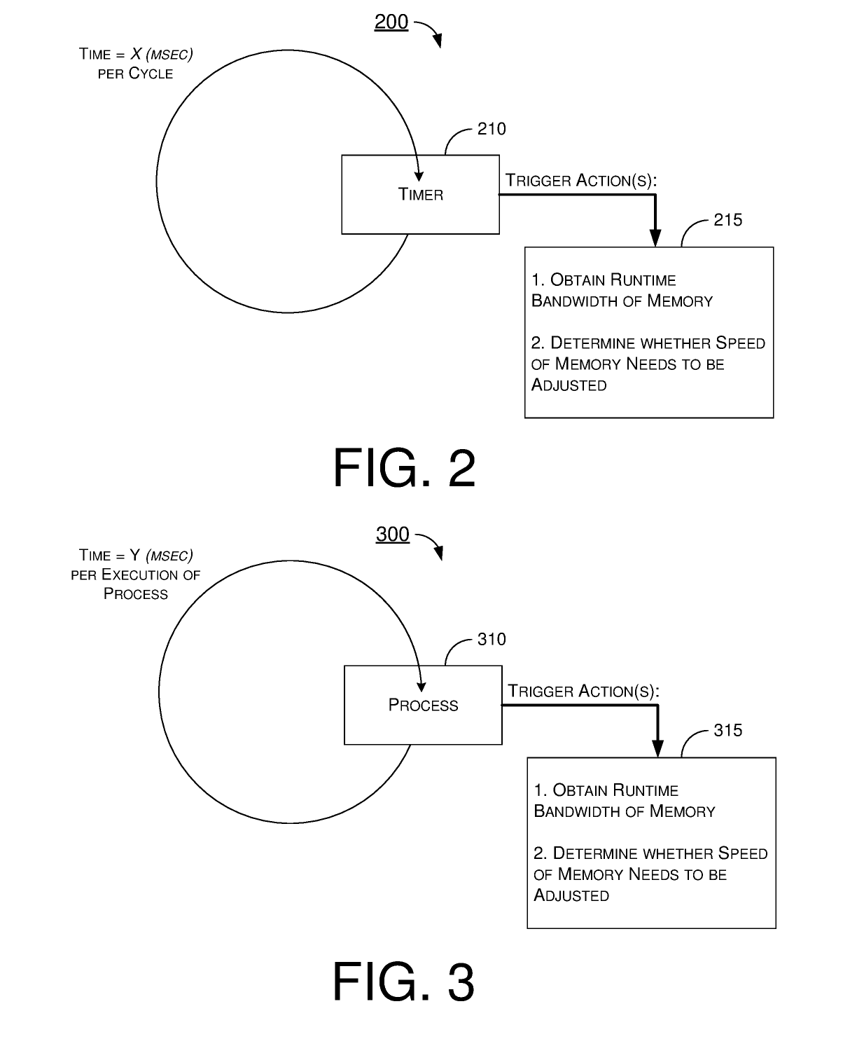

The control logic may be a daemon-like mechanism which is simple and easy to maintain, and may be implemented by a Linux timer and work queue. For instance, the control logic may be implemented with three components. The first component may be information on the runtime bandwidth of the memory device, which may be provided by hardware directly. The second component may be a memory clock (memclk) setting application programming interface (API) to obtain the clock rate (or speed) of the memory device from, which may also be provided by hardware directly. The third component may be a daemon process or timer function, which may be implemented in software or hardware. FIG. 2-FIG. 4 illustrate various examples of how the daemon process and timer function may be implemented.

FIG. 2 illustrates an example scenario 200 in accordance with an implementation of the present disclosure. In scenario 200 one or more operations may be performed periodically according to a counter or timer. In the example shown in FIG. 2, scenario 200 includes a timer 210 with a cycle time of X milliseconds. Thus, after the passage of every X milliseconds according to timer 210, one or more operations 215 may be performed. The one or more operations 215 may include checking, obtaining, detecting or otherwise determining the runtime bandwidth of the memory device and determining whether the speed of the memory device needs to be adjusted.

FIG. 3 illustrates an example scenario 300 in accordance with another implementation of the present disclosure. In scenario 300 one or more operations may be performed periodically according to a process (e.g., daemon process). In the example shown in FIG. 3, scenario 300 includes a process 310 having an execution time of Y milliseconds. Thus, after the execution of process 310 which takes Y milliseconds, one or more operations 315 may be performed. The one or more operations 315 may include checking, obtaining, detecting or otherwise determining the runtime bandwidth of the memory device and determining whether the speed of the memory device needs to be adjusted.

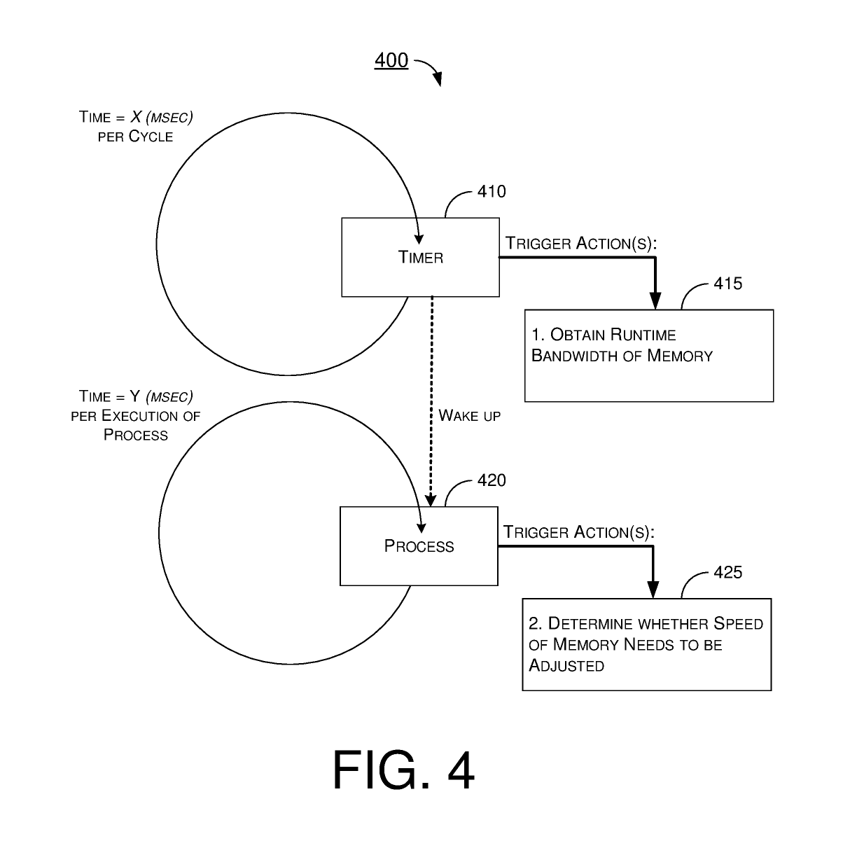

FIG. 4 illustrates an example scenario 400 in accordance with yet another implementation of the present disclosure. In scenario 400 one or more operations may be performed periodically according to a counter or timer as well as a process (e.g., daemon process). In the example shown in FIG. 4, scenario 400 includes a timer 410 with a cycle time of X milliseconds and a process 420 having an execution time of Y milliseconds. That is, after the passage of every X milliseconds according to timer 410, one or more operations 415 may be performed and, after the execution of process 420 which takes Y milliseconds, one or more operations 425 may be performed. The one or more operations 415 may include checking, obtaining, detecting or otherwise determining the runtime bandwidth of the memory device. The one or more operations 425 may include determining whether the speed of the memory device needs to be adjusted.

### Example Implementations

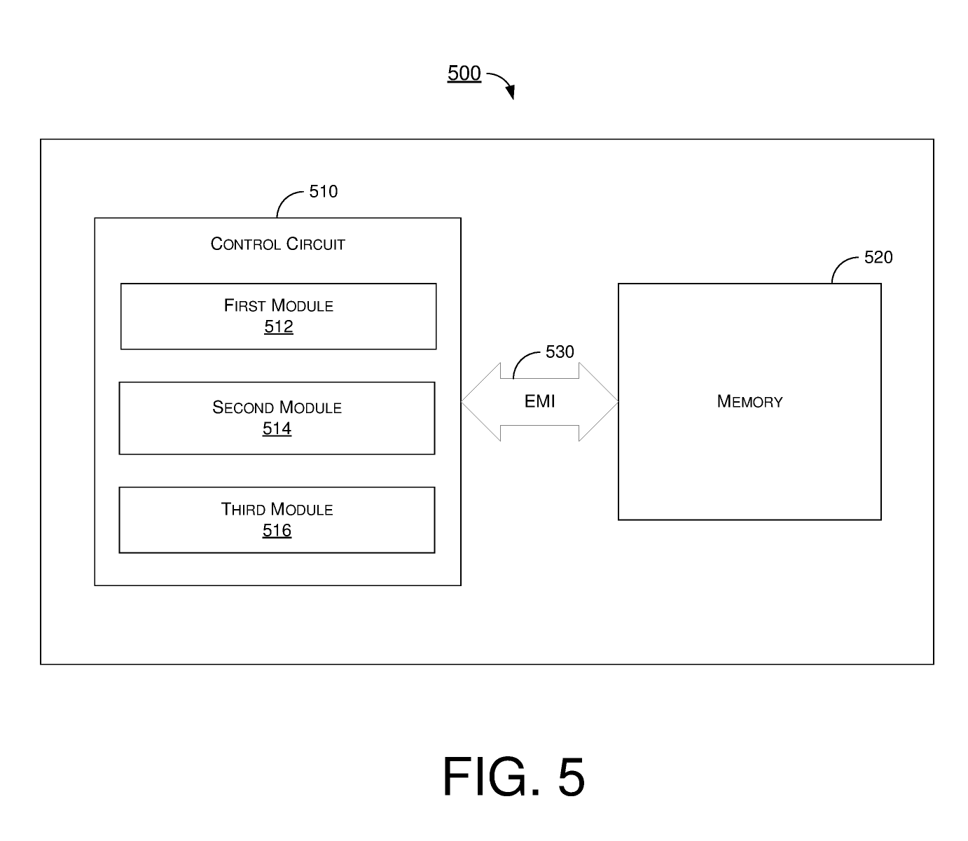

FIG. 5 illustrates an example apparatus 500 in accordance with an implementations of the present disclosure. Apparatus 500 may perform various functions to implement techniques, methods and systems described herein, including algorithm 100, scenario 200, scenario 300 and scenario 400 described above as well as processes 700 and 800 described below. Apparatus 500 may be configured to operate on an external power supply or an internal power supply (e.g., battery). Apparatus 500 may be an electronic apparatuses such as a computing apparatus, and apparatus 500 may be portable and/or wearable. For instance, apparatus 500 may be a smartphone, a wearable device or a computing device such as, for example, a tablet computer, a laptop computer or a notebook computer. In some implementations, apparatus 500 may be a single integrated-circuit (IC) chip, multiple IC chips or a chipset.

Apparatus 500 may include at least those components shown in FIG. 5, such as a control circuit 510. In some implementations, apparatus 500 may also include a memory device 520 and an external memory interface (EMI) 530 coupled between control circuit 510 and memory device 520 so that control circuit 510 and memory device 520 can communicate with each other. Although in FIG. 5 both memory device 520 and EMI 530 are depicted as internal parts of apparatus 500, in some implementations either or both memory device 520 and EMI 530 are external to apparatus 500. Memory device 520 may be, for example, a type of random-access memory (RAM) such as dynamic random-access memory (DRAM), static random-access memory (SRAM) or magnetoresistive random-access memory (MRAM).

Control circuit 510 may include a first module 512, a second module 514 and a third module 516. Each of first module 512, second module 514 and third module 516 may be implemented in the form of software, firmware, middleware and/or hardware. At least one of first module 512, second module 514 and third module 516 may be at least partially implemented as hardware such as a circuit including one or more transistors, one or more diodes, one or more capacitors, one or more resistors, one or more inductors and/or one or more memristors.

First module 512 may be configured to provide a trigger signal from time to time (e.g., periodically or non-periodically). Second module 514 may be configured to receive the trigger signal and obtain information indicative of memory transactions associated with memory device 520 from EMI 530 which is coupled to memory device 520 responsive to receiving the trigger signal from first module 512. Second module 514 may be also configured to determine a runtime bandwidth of memory device 520 according to the memory transactions. Second module 514 may be further configured to compare the runtime bandwidth of memory device 520 to one or more threshold bandwidths. Third module 516 may be configured to adjust the speed of memory device 520 according to a result of the comparing by second module 514. It is noteworthy that memory device 520 may communicate with one or more other users (not shown) via EMI 530, meaning that the information indicative of memory transactions associated with memory device 520 may include not only memory transactions between memory device 520 and control circuit 510 but also memory transactions between memory device 520 and the one or more other users. Accordingly, the determined runtime bandwidth of memory device 520 may reflect communications of memory device 520 with the control circuit 510 and the one or more other users. The term “one or more other users” herein refers to one or more devices, components and/or modules in the form of hardware, software, middleware, firmware, or any combination thereof.

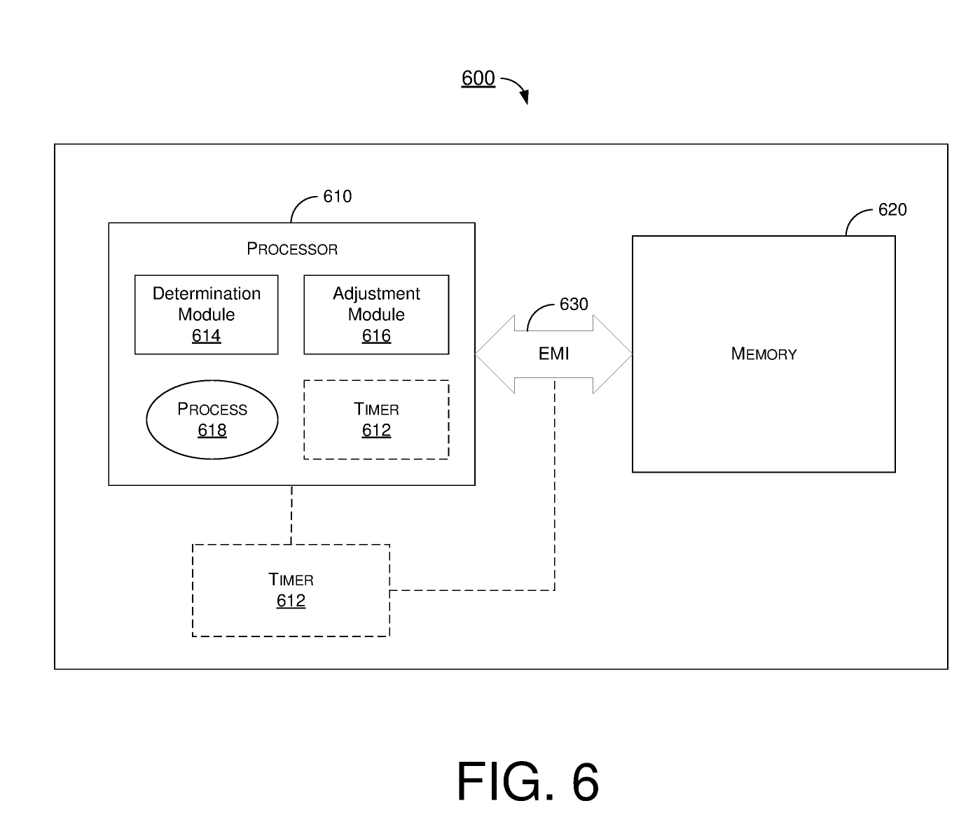

FIG. 6 illustrates an example apparatus 600 in accordance with an implementations of the present disclosure. Apparatus 600 may perform various functions to implement techniques, methods and systems described herein, including algorithm 100, scenario 200, scenario 300 and scenario 400 described above as well as processes 700 and 800 described below. Apparatus 600 may be configured to operate on an external power supply or an internal power supply (e.g., battery). Apparatus 600 may be an electronic apparatuses such as a computing apparatus, and apparatus 600 may be portable and/or wearable. For instance, apparatus 600 may be a smartphone, a wearable device or a computing device such as, for example, a tablet computer, a laptop computer or a notebook computer. In some implementations, apparatus 600 may be a single IC chip, multiple IC chips or a chipset.

Apparatus 600 may include at least those components shown in FIG. 6, such as a processor 610. In some implementations, apparatus 600 may also include a memory device 620 and an EMI 630 coupled between processor 610 and memory device 620 so that processor 610 and memory device 620 can communicate with each other. Although in FIG. 6 both memory device 620 and EMI 630 are depicted as internal parts of apparatus 600, in some implementations either or both memory device 620 and EMI 630 are external to apparatus 600. Memory device 620 may be, for example, a type of RAM such as DRAM, SRAM or MRAM.

Processor 610 may include a determination module 614 and an adjustment module 616. Processor 610 may also include a timer 612. Alternatively, timer 612 may be external to processor 610. In either case, timer 612 may configured to access EMI 630. Each of determination module 614, adjustment module 616 and timer 612 may be implemented in the form of software, firmware, middleware and/or hardware. At least one of determination module 614, adjustment module 616 and timer 612 may be at least partially implemented as hardware such as a circuit including one or more transistors, one or more diodes, one or more capacitors, one or more resistors, one or more inductors and/or one or more memristors.

Apparatus 600 may be an example implementation of apparatus 500. That is, processor 610 may be an example implementation of control circuit 510, timer 612 may be an example implementation of first module 512, determination module 614 may be an example implementation of second module 514, and adjustment module 616 may be an example implementation of third module 516. Accordingly, features, capabilities and functions of timer 612, determination module 614 and adjustment module 616 described herein may be applicable to first module 512, second module 514 and third module 516, respectively.

Determination module 614 may be configured to dynamically detect a runtime bandwidth of memory device 620. Adjustment module 616 may be configured to adjust a speed of memory device 620 responsive to the detecting.

In some implementations, in dynamically detecting the runtime bandwidth of memory device 620, determination module 614 may be configured to detect the runtime bandwidth of memory device 620 non-periodically from time to time. Alternatively, in dynamically detecting the runtime bandwidth of memory device 620, determination module 614 may be configured to periodically detect the runtime bandwidth of memory device 620. It is noteworthy that memory device 620 may communicate with one or more other users (not shown) via EMI 630, meaning that the information indicative of memory transactions associated with memory device 620 may include not only memory transactions between memory device 620 and processor 610 but also memory transactions between memory device 620 and the one or more other users. Accordingly, the determined runtime bandwidth of memory device 620 may reflect communications of memory device 620 with the processor 610 and the one or more other uses. The term “one or more other users” herein refers to one or more devices, components and/or modules in the form of hardware, software, middleware, firmware, or any combination thereof.

In some implementations, in detecting the runtime bandwidth of memory device 620, determination module 614 may be configured to obtain information indicative of memory transactions associated with memory device 620 from an EMI 630 coupled to memory device 620. Additionally, determination module 614 may be configured to determine a runtime bandwidth of memory device 620 according to the memory transactions. In some implementations, in determining the runtime bandwidth of memory device 620 according to the memory transactions, determination module 614 may be configured to obtain from timer 612 a counted value indicative of an amount of data transmitted by memory device 620 through EMI 630. For instance, timer 612, as a hardware circuit, may be communicatively coupled to EMI 630 and configured to count the value which is indicative of the amount of data transmitted by memory device 620 through EMI 630. Moreover, determination module 614 may be configured to divide the amount of data transmitted through EMI 630 by a length of time during which the amount of data was transmitted to obtain the runtime bandwidth. Alternatively or additionally, in obtaining the counted value, determination module 614 may be configured to execute a processor-executable process 618 to perform a function of timer 612 that counts the value.

In some implementations, in adjusting the speed of memory device 620, adjustment module 616 may be configured to adjust a supply voltage of memory device 620, a clock rate of memory device 620, or both.

In some implementations, in adjusting the speed of memory device 620, adjustment module 616 may be configured to compare the runtime bandwidth of memory device 620 to one or more threshold bandwidths. Additionally, adjustment module 616 may be configured to decrease, maintain, or increase the speed of memory device 620 according to a result of the comparing. In some implementations, adjustment module 616 may be configured to decrease the speed of memory device 620 responsive to a comparison result that the runtime bandwidth is lower than one threshold bandwidth of the one or more threshold bandwidths. Additionally, adjustment module 616 may be configured to increase the speed of memory device 620 responsive to a comparison result that the runtime bandwidth is higher than one threshold bandwidth of the one or more threshold bandwidths. Moreover, adjustment module 616 may be configured to maintain the speed of memory device 620 responsive to a comparison result that the runtime bandwidth is within a predetermined range of bandwidths. That is, when the current runtime bandwidth of memory device 620 is within a range (e.g., between the low threshold bandwidth and the high threshold bandwidth), there may not be a need to adjust the speed of memory device 620.

In some implementations, there may be a single threshold bandwidth. Accordingly, there may be a high speed and a low speed at which for memory device 620 to operate, with the high speed corresponding to a runtime bandwidth that is higher than the single threshold bandwidth and the low speed corresponding to a runtime bandwidth that is lower than the single threshold bandwidth. Thus, when the runtime bandwidth of memory device 620 detected or otherwise determined by determination module 614 is higher than the single threshold bandwidth, adjustment module 616 may increase the speed of memory device 620 to the high speed if the current speed of memory device 620 is at the low speed. On the other hand, if the current speed of memory device 620 is already at the high speed, adjustment module 616 may maintain the current speed of memory device 620. Similarly, when the runtime bandwidth of memory device 620 detected or otherwise determined by determination module 614 is lower than the single threshold bandwidth, adjustment module 616 may decrease the speed of memory device 620 to the low speed if the current speed of memory device 620 is at the high speed. On the other hand, if the current speed of memory device 620 is already at the low speed, adjustment module 616 may maintain the current speed of memory device 620.

In some implementations, there may be multiple threshold bandwidths and, correspondingly, there may be multiple ranges in which the current runtime bandwidth of memory device 620 may fall. As an example, there may be three different threshold bandwidths, TB1, TB2 and TB3, with TB1 lower than TB2 and TB2 lower than TB3. Accordingly, the current runtime bandwidth of memory 620 may be in one of the following ranges of bandwidths at a given time: a first range lower than TB1, a second range between TB1 and TB2, a third range between TB2 and TB3, and a fourth range higher than TB3. In this example, there may be multiple speeds at which memory device 620 may operate, including speed 1, speed 2, speed 3 and speed 4, with speed 1 corresponding to the first range of bandwidths, speed 2 corresponding to the second range of bandwidths, speed 3 corresponding to the third range of bandwidths, and speed 4 corresponding to the fourth range of bandwidths. Thus, depending on what the current runtime bandwidth of memory device 620 as detected or otherwise determined by determination module 614 may be in view of the current speed at which memory device 620 operates, adjustment module 616 may decrease, maintain or increase the speed of memory device 620 accordingly. That is, when the current runtime bandwidth of memory device 620 as determined by determination module 614 corresponds to the current speed of memory device 620, adjustment module 616 may maintain the speed of memory device 620 as is. Otherwise, when the current runtime bandwidth of memory device 620 as determined by determination module 614 does not correspond to the current speed of memory device 620, adjustment module 616 may either decrease of increase the speed of memory device 620 so that the speed of memory device 620 after the adjustment corresponds to the current runtime bandwidth thereof.

In some implementations, prior to comparing the runtime bandwidth of memory device 620 to the one or more threshold bandwidths, adjustment module 616 may be configured to determine the one or more threshold bandwidths according to a system condition in which memory device 620 is operating. Alternatively or additionally, prior to comparing the runtime bandwidth of memory device 620 to the one or more threshold bandwidths, adjustment module 616 may be further configured to determine a current operational state of memory device 620 or apparatus 600 including memory device 620 or processor 610 cooperating with the memory device 620 as a first operational state of a plurality of operational states of memory device 620. Furthermore, adjustment module 616 may be configured to select a first threshold bandwidth from a plurality of threshold bandwidths respectively corresponding to the plurality of operational states of memory device 620 or apparatus 600 including memory device 620 or processor 610 cooperating with memory device 620, the first threshold bandwidth corresponding to the first operational state of memory device 620 or apparatus 600 including memory device 620 or processor 610 cooperating with memory device 620.

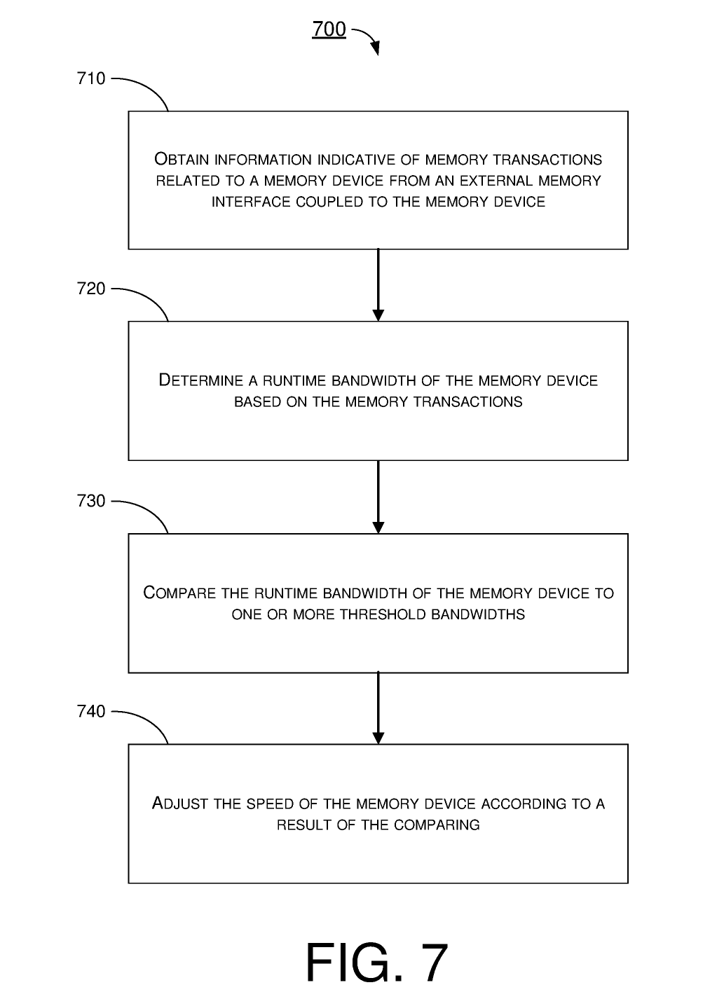

FIG. 7 illustrates an example process 700 in accordance with an implementation of the present disclosure. Process 700 may include one or more operations, actions, or functions as represented by one or more blocks such as blocks 710, 720, 730 and 740. Although illustrated as discrete blocks, various blocks of process 700 may be divided into additional blocks, combined into fewer blocks, or eliminated, depending on the desired implementation. Process 700 may be implemented by apparatus 500. Solely for illustrative purpose and without limiting the scope of the present disclosure, process 700 is described below in the context of process 700 being performed by apparatus 500. Process 700 may begin at 710.

At 710, process 700 may involve second module 514 obtaining information indicative of memory transactions associated with memory device 520 from EMI 530 which is coupled to memory device 520. Second module 514 may obtain the information indicative of the memory transactions associated with memory device 520 as a result of periodically or non-periodically receiving a trigger signal from first module 512. Memory device 520 may be, for example, a DRAM. Process 700 may proceed from 710 to 720.

At 720, process 700 may involve second module 514 determining a runtime bandwidth of memory device 520 according to the memory transactions. Process 700 may proceed from 720 to 730.

At 730, process 700 may involve second module 514 comparing the runtime bandwidth of memory device 520 to one or more threshold bandwidths. Process 700 may proceed from 730 to 740.

At 740, process 700 may involve third module 516 adjusting the speed (e.g., frequency or clock rate) of memory device 520 according to a result of the comparing.

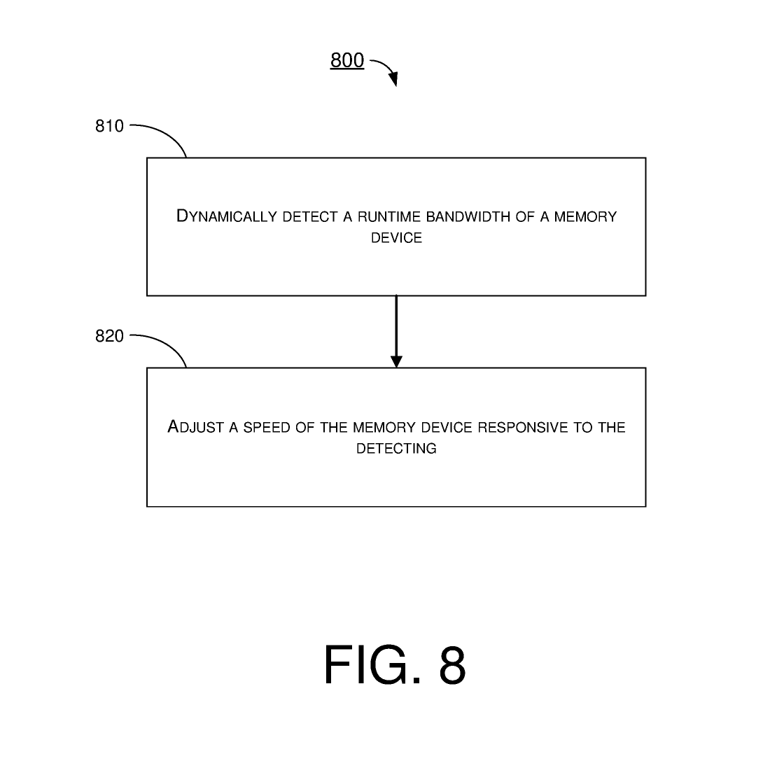

FIG. 8 illustrates an example process 800 in accordance with an implementation of the present disclosure. Process 800 may include one or more operations, actions, or functions as represented by one or more blocks such as blocks 810 and 820. Although illustrated as discrete blocks, various blocks of process 800 may be divided into additional blocks, combined into fewer blocks, or eliminated, depending on the desired implementation. Process 800 may be implemented by apparatus 600. Solely for illustrative purpose and without limiting the scope of the present disclosure, process 800 is described below in the context of process 800 being performed by apparatus 600. Process 800 may begin at 810.

At 810, process 800 may involve processor 610 dynamically detecting a runtime bandwidth of memory device 620. Memory device 620 may be, for example, a DRM. Process 800 may proceed from 810 to 820.

At 820, process 800 may involve processor 610 adjusting a speed (e.g., frequency or clock rate) of memory device 620 responsive to the detecting.

In some implementations, in dynamically detecting the runtime bandwidth of memory device 620, process 800 may involve processor 610 detecting the runtime bandwidth of memory device 620 non-periodically from time to time. Alternatively, in dynamically detecting the runtime bandwidth of memory device 620, process 800 may involve processor 610 periodically detecting the runtime bandwidth of memory device 620.

In some implementations, in detecting the runtime bandwidth of memory device 620, process 800 may involve processor 610 obtaining information indicative of memory transactions associated with memory device 620 from EMI 630 which is coupled to memory device 620. Process 800 may also involve process 610 determining a runtime bandwidth of memory device 620 according to the memory transactions. In some implementations, in determining the runtime bandwidth of memory device 620 according to the memory transactions, process 800 may involve processor 610 obtaining from timer 612 a counted value indicative of an amount of data transmitted by memory device 620 through EMI 630. Process 800 may also involve processor 610 dividing the amount of data transmitted through external memory interface 630 by a length of time during which the amount of data was transmitted to obtain the runtime bandwidth. In some implementation, in obtaining the counted value, process 800 may involve processor 610 executing processor-executable process 618 to perform a function of a timer that counts the value.

In some implementations, in adjusting the speed of memory device 620, process 800 may involve processor 610 adjusting at least one of a supply voltage and a clock rate of memory device 620.

In some implementations, in adjusting the speed of memory device 620, process 800 may involve processor 610 comparing the runtime bandwidth of memory device 620 to one or more threshold bandwidths. Process 800 may also involve processor 610 decreasing, maintaining, or increasing the speed of memory device 620 according to a result of the comparing.

In some implementations, in decreasing, maintaining, or increasing the speed of memory device 620 according to the result of the comparing, process 800 may involve processor 610 decreasing the speed of memory device 620 responsive to a comparison result that the runtime bandwidth is lower than one threshold bandwidth of the one or more threshold bandwidths. Alternatively or additionally, in decreasing, maintaining, or increasing the speed of memory device 620 according to the result of the comparing, process 800 may involve processor 610 increasing the speed of memory device 620 responsive to a comparison result that the runtime bandwidth is higher than one threshold bandwidth of the one or more threshold bandwidths. Alternatively or additionally, in decreasing, maintaining, or increasing the speed of memory device 620 according to the result of the comparing, process 800 may involve processor 610 maintaining the speed of memory device 620 responsive to a comparison result that the runtime bandwidth is within a predetermined range of bandwidths.

In some implementations, prior to comparing the runtime bandwidth of memory device 620 to the one or more threshold bandwidths, process 800 may involve processor 610 determining the one or more threshold bandwidths according to a system condition in which memory device 620 is operating. Alternatively or additionally, prior to comparing the runtime bandwidth of memory device 620 to the one or more threshold bandwidths, process 800 may involve processor 610 determining a current operational state of memory device 620 and/or apparatus 600 and/or processor 610 including or cooperating with memory device 620 as a first operational state of a plurality of operational states of memory device 620 or apparatus 600/processor 610 including or cooperating with memory device 620. Additionally, process 800 may involve processor 610 employing the same threshold bandwidth regardless of the operational state of memory device 620 and/or apparatus 600. Alternatively, process 800 may involve processor 610 selecting a first threshold bandwidth from a plurality of threshold bandwidths respectively corresponding to the plurality of operational states of memory device 620 and/or apparatus 600 and/or processor 610, the first threshold bandwidth corresponding to the first operational state of memory device 620 and/or apparatus 600 and/or processor 610.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method for dynamically adjusting a speed of a memory device, comprising:
obtaining information indicative of memory transactions associated with a memory device from an external memory interface coupled to the memory device;
determining a runtime bandwidth of the memory device according to the memory transactions;
comparing the runtime bandwidth of the memory device to one or more threshold bandwidths; and
adjusting the speed of the memory device according to a result of the comparing.

2. The method of claim 1, wherein the obtaining of the information indicative of the memory transactions associated with the memory device comprises obtaining information indicative of memory transactions associated with a dynamic random-access memory (DRAM).

3. An apparatus, comprising:
a first module configured to provide a trigger signal from time to time;
a second module configured to receive the trigger signal and obtain information indicative of memory transactions associated with a memory device from an external memory interface coupled to the memory device responsive to receiving the trigger signal, the second module also configured to determine a runtime bandwidth of the memory device according to the memory transactions, the second module further configured to compare the runtime bandwidth of the memory device to one or more threshold bandwidths; and
a third module configured to adjust the speed of the memory device according to a result of the comparing by the second module,
wherein at least one of the first module, the second module and the third module is implemented at least partially in hardware.

4. The apparatus of claim 3, further comprising:
the memory device, wherein the memory device comprises a dynamic random-access memory (DRAM).

5. A method, comprising:
dynamically detecting a runtime bandwidth of a memory device; and
adjusting a speed of the memory device responsive to the detecting.

6. The method of claim 5, wherein the dynamically detecting of the runtime bandwidth of the memory device comprises dynamically detecting a runtime bandwidth of a dynamic random-access memory (DRAM).

7. The method of claim 5, wherein the dynamically detecting of the runtime bandwidth of the memory device comprises detecting the runtime bandwidth of the memory device non-periodically from time to time.

8. The method of claim 5, wherein the dynamically detecting of the runtime bandwidth of the memory device comprises periodically detecting the runtime bandwidth of the memory device.

9. The method of claim 5, wherein the detecting of the runtime bandwidth of the memory device comprises:
obtaining information indicative of memory transactions associated with the memory device from an external memory interface coupled to the memory device; and
determining a runtime bandwidth of the memory device according to the memory transactions.

10. The method of claim 9, wherein the determining of the runtime bandwidth of the memory device according to the memory transactions comprises:
obtaining a value counted by a timer, the counted value indicative of an amount of data transmitted by the memory device through the external memory interface; and
dividing the amount of data transmitted through the external memory interface by a length of time during which the amount of data was transmitted to obtain the runtime bandwidth.

11. The method of claim 10, wherein the obtaining of the value counted by the timer comprises executing a processor-executable process to perform a function of the timer.

12. The method of claim 10, wherein the obtaining of the value counted by the timer comprises obtaining the counted value from a hardware circuit functioning as the timer, and wherein the hardware circuit is coupled to the external memory interface.

13. The method of claim 5, wherein the adjusting of the speed of the memory device comprises adjusting at least one of a supply voltage and a clock rate of the memory device.

14. The method of claim 5, wherein the adjusting of the speed of the memory device comprises:
comparing the runtime bandwidth of the memory device to one or more threshold bandwidths; and
decreasing, maintaining, or increasing the speed of the memory device according to a result of the comparing.

15. The method of claim 14, wherein the decreasing, maintaining, or increasing of the speed of the memory device according to the result of the comparing comprises decreasing the speed of the memory device responsive to a comparison result that the runtime bandwidth is lower than one threshold bandwidth of the one or more threshold bandwidths.

16. The method of claim 14, wherein the decreasing, maintaining, or increasing of the speed of the memory device according to the result of the comparing comprises increasing the speed of the memory device responsive to a comparison result that the runtime bandwidth is higher than one threshold bandwidth of the one or more threshold bandwidths.

17. The method of claim 14, wherein the decreasing, maintaining, or increasing of the speed of the memory device according to the result of the comparing comprises maintaining the speed of the memory device responsive to a comparison result that the runtime bandwidth is within a predetermined range of bandwidths.

18. The method of claim 14, further comprising:
prior to comparing the runtime bandwidth of the memory device to the one or more threshold bandwidths, determining the one or more threshold bandwidths according to a system condition in which the memory device is operating.

19. The method of claim 14, further comprising:
prior to comparing the runtime bandwidth of the memory device to the one or more threshold bandwidths, performing operations comprising:
determining a current operational state of the memory device or an apparatus including or cooperating with the memory device as a first operational state of a plurality of operational states of the memory device or the apparatus including or cooperating with the memory device; and
selecting a first threshold bandwidth from a plurality of threshold bandwidths respectively corresponding to the plurality of operational states of the memory device or the apparatus including or cooperating with the memory device, the first threshold bandwidth corresponding to the first operational state of the memory device or the apparatus including or cooperating with the memory device.

20. An apparatus, comprising:
a processor coupled to a memory device and configured to dynamically detect a runtime bandwidth of the memory device, the processor further configured to adjust a speed of the memory device responsive to the detecting.

21. The apparatus of claim 20, further comprising:
an external memory interface; and
a dynamic random-access memory (DRAM) as the memory device, wherein the DRAM is communicatively coupled to the processor through the external memory interface.

22. The apparatus of claim 20, wherein, in dynamically detecting the runtime bandwidth of the memory device, the processor is configured to detect the runtime bandwidth of the memory device non-periodically from time to time.

23. The apparatus of claim 20, wherein, in dynamically detecting the runtime bandwidth of the memory device, the processor is configured to periodically detect the runtime bandwidth of the memory device.

24. The apparatus of claim 20, wherein, in detecting the runtime bandwidth of the memory device, the processor is configured to perform operations comprising:
obtaining information indicative of memory transactions associated with the memory device from an external memory interface coupled to the memory device; and
determining a runtime bandwidth of the memory device according to the memory transactions.

25. The apparatus of claim 24, wherein, in determining the runtime bandwidth of the memory device according to the memory transactions, the processor is configured to perform operations comprising:
obtaining a counted value indicative of an amount of data transmitted by the memory device through the external memory interface; and
dividing the amount of data transmitted through the external memory interface by a length of time during which the amount of data was transmitted to obtain the runtime bandwidth.

26. The apparatus of claim 25, in obtaining the counted value, the processor is configured to execute a processor-executable process to perform a function of a timer that counts the value.

27. The apparatus of claim 25, further comprising:
a timer circuit configured to count the value which is indicative of the amount of data transmitted by the memory device through the external memory interface, wherein the timer circuit is coupled to the external memory interface.

28. The apparatus of claim 20, wherein, in adjusting the speed of the memory device, the processor is configured to adjust at least one of a supply voltage and a clock rate of the memory device.

29. The apparatus of claim 20, wherein, in adjusting the speed of the memory device, the processor is configured to perform operations comprising:
comparing the runtime bandwidth of the memory device to one or more threshold bandwidths; and
decreasing, maintaining, or increasing the speed of the memory device according to a result of the comparing.

30. The apparatus of claim 29, wherein, in decreasing, maintaining, or increasing the speed of the memory device according to the result of the comparing, the processor is configured to decrease the speed of the memory device responsive to a comparison result that the runtime bandwidth is lower than one threshold bandwidth of the one or more threshold bandwidths.

31. The apparatus of claim 30, wherein, in decreasing, maintaining, or increasing the speed of the memory device according to the result of the comparing, the processor is configured to increase the speed of the memory device responsive to a comparison result that the runtime bandwidth is higher than one threshold bandwidth of the one or more threshold bandwidths.

32. The apparatus of claim 30, wherein, in decreasing, maintaining, or increasing the speed of the memory device according to the result of the comparing, the processor is configured to maintain the speed of the memory device responsive to a comparison result that the runtime bandwidth is within a predetermined range of bandwidths.

33. The apparatus of claim 29, wherein, prior to comparing the runtime bandwidth of the memory device to the one or more threshold bandwidths, the processor is further configured to determine the one or more threshold bandwidths according to a system condition in which the memory device is operating.

34. The apparatus of claim 29, wherein, prior to comparing the runtime bandwidth of the memory device to the one or more threshold bandwidths, the processor is further configured to perform operations comprising:
determining a current operational state of the memory device or an apparatus including or cooperating with the memory device as a first operational state of a plurality of operational states of the memory device or the apparatus including or cooperating with the memory device; and
selecting a first threshold bandwidth from a plurality of threshold bandwidths respectively corresponding to the plurality of operational states of the memory device or the apparatus including or cooperating with the memory device, the first threshold bandwidth corresponding to the first operational state of the memory device or the apparatus including or cooperating with the memory device.
